(19) United States
(12) Patent Application Publication
(10) Pub. No.: US 2018/0335512 A1
(43) Pub. Date: Nov. 22, 2018

(54) mm-Wave Radar Sensor for Distance Measurement in Short and Medium Range

(71) Applicants: Veselin Brankovic, Belgrade (RS); Veljko Mihajlovic, Belgrade (RS); Djordje Glavonjic, Kaludjerica (RS); Darko Tasovac, Belgrade (RS)

(72) Inventors: Veselin Brankovic, Belgrade (RS); Veljko Mihajlovic, Belgrade (RS); Djordje Glavonjic, Kaludjerica (RS); Darko Tasovac, Belgrade (RS)

(73) Assignee: Novelic d.o.o., Belgrade (RS)

(21) Appl. No.: 15/599,491

(22) Filed: May 19, 2017

(51) Int. Cl. G01S 13/44; G01S 13/93; G01S 13/58

(52) U.S. Cl. CPC G01S 13/44; G01S 13/931; G01S 2013/9389; G01S 2013/9314; G01S 13/584

(57) ABSTRACT

The present invention discloses an mm-wave radar sensor to be deployed in the vehicles for parking sensor, as well as in industrial environments, robotics environments and other environments for addressing distance calculations from 0 cm to above 10 m.

The key system relevant components of the proposed systems are: utilization of mm-wave integrated radar SOC, supporting FMCW radar operation principle and CW radar operations, with additional analog functionality being integrated on SOC, planar antenna structure, and specific method of operation of switching from FMCW operation mode to the CW operation mode.

Preferably, the system, being integrated as HW module with SW components is using non licensed 60 GHz or 77-79 GHz frequency band with integrated RF radar SOC with PLL, with physical size less than 2×2×0.5 cm, and it is used for moving and parking assistance, being integrated as invisible in the vehicle body.

mm-Wave Radar System Apparatus and Method of Operation for simultaneous medium distance and short distance sensing.

### TECHNICAL FIELD

The present invention relates to a mm-Wave Radar Sensor apparatus concept and radar sensor operation method addressing capability to detected simultaneously medium distances larger than 10 m as well as short distances, below 20 cm.

### BACKGROUND ART

There is a strong motivation to deploy the low cost, miniature small distance sensors particularly in the following applications:
a) Distance detection of the objects inside the vehicle cabin
b) Distance detection of the objects outside of the vehicle cabin
c) Distance detection for industrial machinery in the production process
d) Distance detection for robotics, movable arms to the objects
   where the family of the applications demands the need to detect the distances covering range from zero distance up to ranges larger than 10 m.

Currently state of the art mm-wave radar systems being on the market are deploying FMCW radar concept, and they are operating in the frequency bands in 60 GHz Range (non-licensed band), 77-81 GHz automotive band, and 120 GHz band ISM band. In all cases integrated System on Chip supporting FMCW radar analog operation with or without PLL on the same die are proposed and used. These SoCs can be in many cases used for Doppler type of applications, where vibrations are detected.

Main application area for mm-wave radar sensor, currently on the market are:
Long range distance detection up to 300 m
Blind spot detection

These applications suffers in short distance detection, and due to the nature of the FMCW radar operations they cannot work for distances below 20 cm, as the obtained frequency which reflects the distance to the target is low.

In this invention we propose an apparatus for the future sensor module and it operations, being able to detect the distances in cm range level, by using other system concept than FMCW radar, based on specific CW mode operation.

The typical and essential application, addressed by this invention is effective calculation of the distance for parking sensor module, being able to replace ultrasound modules addresses distance sensing from 0 cm up to above 10 m, being fully integrated in the automotive enclosure, like in bumpers and fully invisible.

The following patents and patent applications published in last several years show the relevance of the topic and the state-of-the-art.

DE 102012201367, “The millimeter wave radar” introduces a millimeter-wave radar device with at least one millimeter wave circuit and at least one antenna, constructed as a module of a multi-layer multi-polymer board.

U.S. Pat. No. 7,782,251, “Mobile millimeter wave imaging radar system” introduces a short range complex millimeter wave imaging radar system, having scanned Tx and Rx antennae.

U.S. Pat. No. 4,929,958, “High precision radar detection system and method” describes the systems with four transducers to accurately determine the azimuth angle of a radar emitting object.

U.S. Pat. No. 8,779,969, “Radar device for detecting azimuth of target” by Denso, describes azimuth detection by analyzing echoes by spectrum performance, excited by frequency ramped signal, mixed by the excitation signal.

U.S. Pat. No. 5,657,027, “A Two dimensional interferometer array”, treats two dimensional problem approach using 4 receiving channels and specific digital processing.

U.S. Pat. No. 6,736,231, “Vehicular occupant motion detection system using radar” introduces ultrasonic radar approach for determining seat occupancy by detecting the vital signs information. Its “radar” based system has two physically separated receivers of reflected ultrasound signals, and two units for further processing.

### SUMMARY OF INVENTION

This invention proposed apparatus 100 and method of operation for distance detection for various applications allowing detecting distances from 0 cm up to more than 10 meters.

The key system relevant components of the proposed apparatus 100 are:
Planar antenna system, realized by the plurality of the technologies, with each of the transmit 21 and receiving 22 parts having radiation diagram in the direction where the distance is to be measured.
Millimeter-wave radar with integrated front end on silicon 10, System on Chip, providing analog processing of the mm-wave signal, and the provision of the analog to digital conversion functionality, having at least one Tx chain, and at least one Rx chain, having full FMCW distance detection operation capability know from the state of art, and having
a) Analog functionality being able to detected power level approaching at least one of the Rx chain before approaching mixing functionality, by using plurality of realization options
b) Functionality to after obtaining the control interrupt switch from FMCW mode operation to the pure CW operation, using specific frequency within its frequency operation capability.
Digital signal processing functionality 40, having standardized physical digital interface 60, with plurality of the realization;

The proposed system combines operation in FMCW and CW Mode. In the state of art non-military radar sensors for distance detection FMCW operation mode is used. This operation mode is especially used and widely deployed for the long range radar automotive system, covering the distances in the 300 m range. There is a strong attempt to used existing long range SoC RF functionalities for detecting distances below 20 cm. This is however hardly possible using FMCW operation mode.

In this innovation we are proposing, changing functional topology of the FMCW analog part with specific analog functionality, and introducing the new operation mode, where FMCW radar operation is switched off to the single frequency CW operations. The complete system observes the detected distances by FMCW operation and incoming power on at least one Rx input in RF SOC. After specific threshold distance L, is achieved, the complete Apparatus 100, is switching to the single frequency CW operation mode. That means the millimeter-wave radar with integrated front end on silicon 10, System on Chip, does not produce frequency ramps, it is starting to produce radiation on only one frequency. The threshold distance L is chosen after empirical evaluation of the sensor application scenario, which imposes the position of the sensor in the environment.

For example in automotive related preferable application for the proposed invention for parking assistance, the aim is to replace the commonly used ultra sound systems by miniature and low cost radar sensors. Radar sensor are integrated in the bumper, or integrated in the lighting systems or in the automotive enclosure. Tx and Rx antennas of the radar system are having specific radiation diagrams. The specific threshold distance L can be set to the value lower than 50 cm, meaning that for distances below 50 cm, the distance is calculated by using primarily set of the polynomial coefficients in the polynomial equations having as unknown information the power of the signal being detected on the Rx input inside of the entity 10, where CW mode is active. The set of the polynomial coefficients are preset by the empirical evaluation of the sensor position and it's actual application. The numbers of the polynomial coefficients are chosen to be minimal by respecting calculation effort from one side and tolerances in mechanical enclosures, which are influencing accuracy just in case as the accuracy in RX power level acquisition. They typical application solution for parking sensor, aiming replacement of the ultrasound systems is proposed, by prosing 2N radiation elements antenna, where N can takes values from 1, 2, 4 or 8, being chosen to provide in elevation area narrow beam to minimize the reflections from driving surface, and in the same time to have wide angle range in azimuth, being explicitly wider as in elevation.

The digital part typically includes CAN and/or LIN interface allowing easy connection to the vehicle infrastructure. The means of short range wireless connection to the vehicle system 63 is optional and suited for the aftermarket usage. In aftermarket mode the proposed apparatus may have integrated audio and/or visual indicators.

### BRIEF DESCRIPTION OF DRAWINGS

FIG. 1 presents general application parking scenario, where the sensors measure distance to one object by state of the art FMCW operation mode, and when the measured distance is below specific small threshold distance L Switch, measured by using proposed innovative approach switch to simple CW mode sending only one frequency.

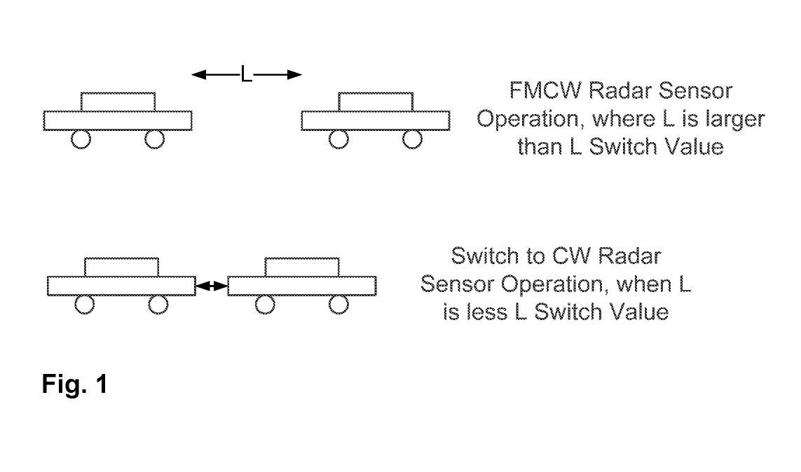

FIG. 2 presents the real case in parking, when the obstacle object is very close to the radar sensor, for the case of the metal surface, and for the case of the metallic cylinder.

FIG. 3 presents the proposed HW topology of the Apparatus 100, with its functional entities, hereby the besides state of the art FMCW entities in the mm-wave SOC 10, new entity 70, “coupling and power detection” is introduced. Further new functional entity 80: “switching mode functionality” in the controlling part of the digital signal processing functionality is introduced.

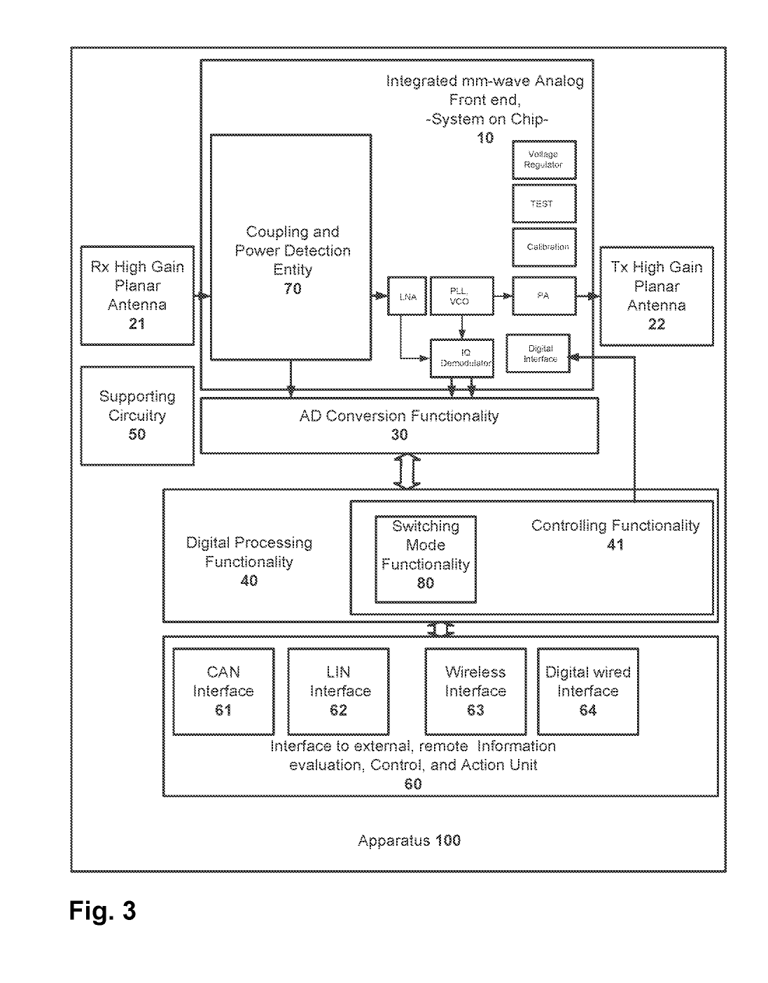

FIG. 4 presents entity 70 and its two sub parts coupling entity 71 and power detection entity 72.

FIG. 5 presents method of operation principle diagram of switching from FMCW mode to single frequency CW Mode of the proposed mm-wave radar based distance sensor.

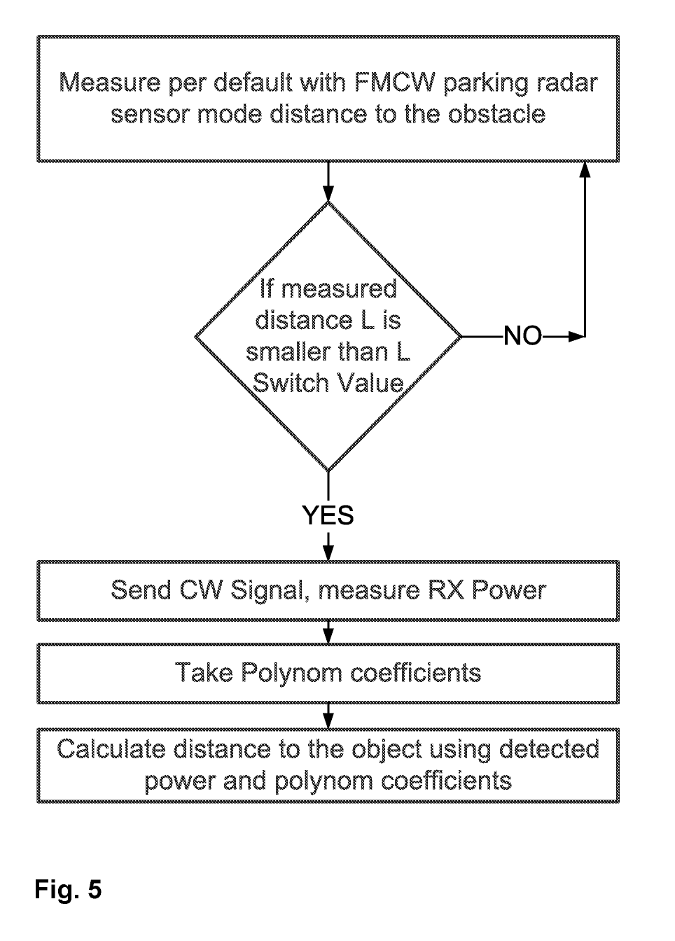

FIG. 6 presents top view of the proposed preferred embodiment Apparatus 100 realization: A) having 4 dipoles with vertical polarization from Rx and Tx antenna systems as well as B) having 4 dipoles with horizontal polarization for Rx and Tx antenna systems

### DESCRIPTION OF EMBODIMENTS

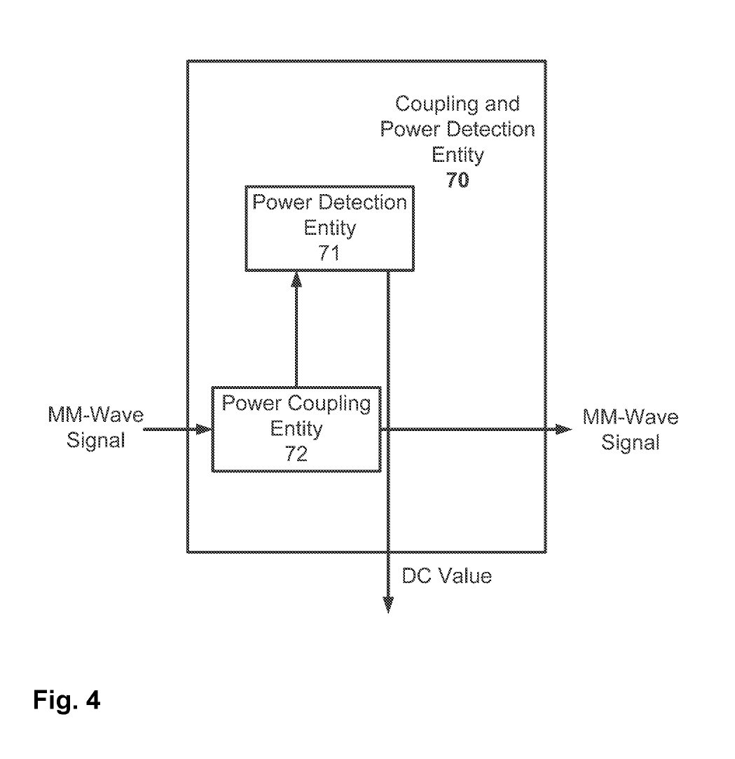

Apparatus 100 is preferably integrated in the vehicle bumper being invisible, having line-of-sight towards the possible obstacles, in front of bumper. The basic generalized purpose of the proposed innovative approach is to provide the measurements of the distance from the sensor to the object. In proposed HW topology of the integrated mm-wave SOC, we are proposing introduction of the entity 70 addressing RF power coupling and RF power detecting, being realized by the plurality of the realization active and passive circuit topologies directly on the integrated RF IC SOC 10. The detail of the Entity 70, is shown in the FIG. 4 introducing entity 71 and entity 72. Entity 72 is coupling very small part of the incoming power, from receive antenna 22 and providing it to the entity 72, where the RF part is passing to the LNA structure and further to IQ demodulator. Due to the integration of the apparatus 100 in the vehicle for example, we have losses in the irradiated power and also if we are aiming to detected object far away, we would need to handle very small RF signal approaching entity 70, and if we would couple a lot of energy we will further influence the radar sensor sensitivity and maximum range to be achieved. Therefore the coupling level is realized to be between 20 and 60 dB, meaning that the detection sensitivity of the power detection entity 72, may be achieved, only if very high RF signal level on the RX antenna 22 is present. On the other hand we have large RF signal level on RX antenna only if the object is very close to the sensor, and the reflections are very high. With this HW approach on the integrated RF IC, being released by the plurality of the topologies we are ensuring that the power detection entity 72, is detecting RF signals only if the object is very close to the sensor apparatus 100, and then as a results of the analog power detection a DC value is sent to the signal processing entity 40, after digitalization in the entity 30. This DC value is proportional to the power being on the RX antenna input. Practical realization of the coupling from the Rx input after antenna on the SOC itself, may be realized by the different means of passive coupling, which may be inherently related to the applied semiconductor technology.

The state of art automotive FMCW radar sensor, which are realized in 77-81 GHz and which are addressing long range ADAS application, may work as close as 20-30 cm to the object. The minimum detection distance is related to the several constrains: FMCW principle, scattering performance of the objects which are highly complex where the distance to the object is close to the object dimensions, and system noise, due to small beat frequency. On the other hand parking sensor applications required the distance measurements below 30 cm typically up to 1-2 cm distance. So therefore we are proposing switching from FMCW mode operation to the single frequency CW operation mode, where the obstacles are close to sensor, as in typical parking application case.

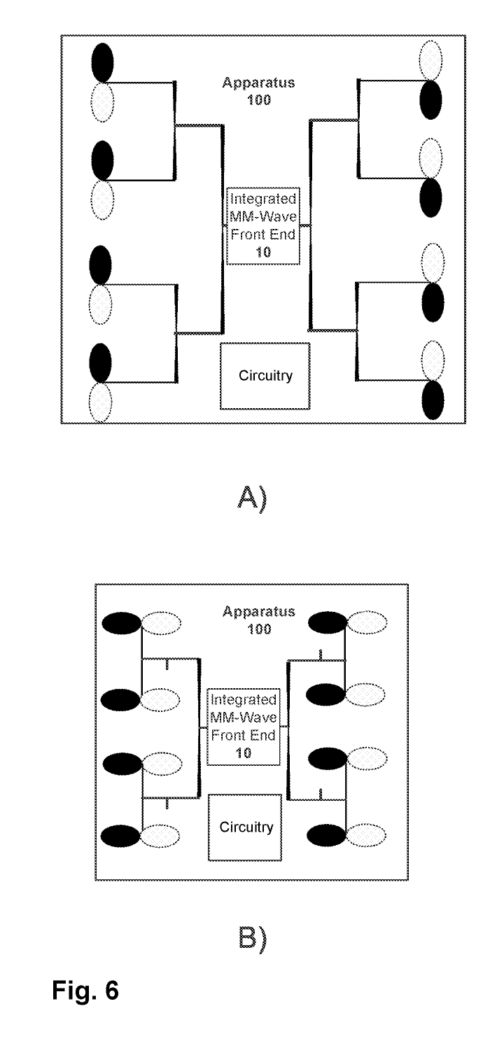

Let us observe following parking sensor application case, being related to the preferable Apparatus embodiment presented in the FIG. 6:

G1 [dBi] TX Antenna Gain inside bumper: 12

G2 [dBi]: RX Antenna Gain inside bumper 12

f [GHz]: 60

RAT [dB]: Losses 7 dB in bumper one way 7

P1 [dBm]: Power fed to Tx antenna after connection losses 8

We are noticing that the EIRP in above case is complying with ISM Band a worldwide regulation EIRP limits for 57-64 GHz operations.

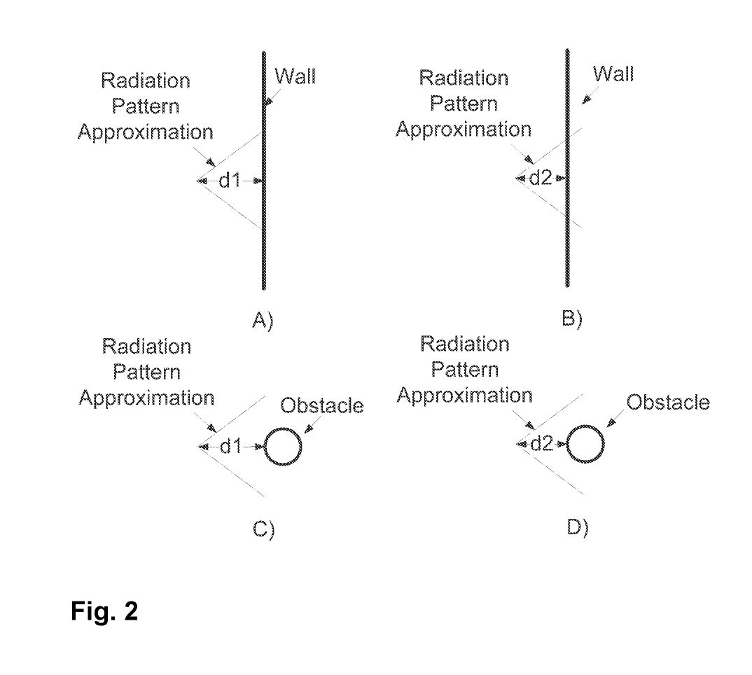

And let us have a typical parking application case where another vehicle, or parking facility wall is close to bumper at 30 cm or less, as it is show in FIG. 2a, and FIG. 2b. In that case we may notice that theoretically almost the whole power irradiated are reflected and sent to RX antenna systems, if the reflecting surface area is infinitely large. We may also notice that, when we are very close to the antenna with large object the complete irradiated power of the antenna beam is reflected. So radar equation is not valid, and we may see that in theoretical case we have a direct mapping between the received power and distance from the antenna to the object. More precise, the behavior of the function is close to the quadrature behavior, which means that with power detection dynamic range of 30 dB we may cope with 30 cm to 1 cm distance detection. Also we have here the physical law that shows that as long as we are near to the radar sensor the ideal reflection is more reals and we have more accurate results. Related coupling can be on more than 30 dB level, so that power detector is starting detecting power levels from −70 to −80 dBm, up to −40 dBm to −50 dBm for example. By using specific high dynamic range power detection topology for power detection entity, being released directly on chip 10, more accuracy in mapping distance to power level may be achieved. By observing FIG. 2c and FIG. 2d, we are observing metallic cylinder obstacle close to the sensor. By observing the figures, it may be intuitively concluded that the receive power level in the comparison with wall will be lower, because part of the radar signals from the antenna beam edges are not scattered in the direction of antenna or they are passing close to the obstacles. On other side as much as obstacle is closer to the sensor the system starts to behave as a reflection from the infinitive size metal area, which behaves as quadrature dependence between distance and detected RF power.

Having this in mind we are introducing polynomial function, which relates detected power at receiver antenna (Prx) and distance to the target (R)

R=f(Prx)

This function maps as a close practical approximation the RX power to the detected distance in the following way:

R=A(PRx)̂(½)+B(PRx)̂(¼)+C

R— distance

Prx=power at the receiving antenna

A,B,C—calculated coefficients to get f

The polynomial coefficients are set after 3D electromagnetic simulations for specific bumper, material, specific vehicle, and specific antenna are conducted, for the set of the key, for practical application relevant, use cases.

After having sets of the parameters, two approaches are proposed:
a) Using set of different parking sensor and information from them, as sensor fusion, the complete system is recognizing at the distances larger that switching frequency the art of the obstacle. By becoming closer to the obstacles the system is using polynomial coefficients being dedicated for the pre-defined type of obstacle.
b) Using limited type of obstacles, the coefficients fitting the highest probability of appearance and minimal quadratic errors are used as one set of coefficients for all type of obstacles.

These coefficients are that in the process of the empirical tuning for each specific vehicles fine-tuned, and provided for the each sensor look up table.

Taking into account proposed 60 GHz ISM band operation, or alternatively 77-79 GHz operation, and 4× antenna elements for 21 and 22, the approximate size of the device may be less than 2×2×0.5 cm, which would inherently allow practical use and integration capability in vehicles or in the industrial embodiment.

The entity 10 is preferably realized using SiGe BiCMOS technology that provides high performance. Alternatively CMOS technology may be used.

AD (analog to digital) conversion functionality 30 converts the analog conditioned signal or two quadrature signals, I and Q, of the entity 10, and feeds digital representation of signal or signals to the Digital processing functionality 40 for further processing. Entity 30 is realized by plurality of the realization options, with sampling frequency typically under 1 MHz and typically at least 8 bit resolution. Entity 30 may be integrated on the same chip as Entity 10. Entity 30 may be integrated on the same chip as Entity 40. Entities 40, 10, and 30 may be all integrated on a single chip. Entity 60 is providing interface to vehicle infrastructure by using typical vehicle wired interfaces like CAN interface 61, and/or LIN interface 62, optional custom digital interface 64, and optional short range wireless interface 63. Standard interface, preferably CAN, is obligatory for all applications where the apparatus is integrated in vehicle during manufacturing. For aftermarket applications the short range wireless interface, preferable Bluetooth, may be integrated in entity 60. Supporting circuitry 50 optionally includes additional memory, manual switching, power supply regulation circuitry, mechanical support, and any additional functionality required for easy integration, during manufacturing or later in aftermarket. The mechanical support structure for integration of all functionality is preferably provided using advanced polymer technologies. Optionally, in case of the aftermarket operation, entity 50 may also include battery, loudspeaker or warning light sources, allowing autonomous operation.

Digital processing functionality 40 may be realized by the plurality of technologies, such as: advanced CPUs, FPGAs, advanced μC, DSP, or ASIC, or their combinations, where the digital processing may be performed by “soft” approach or by hard-wired approach or by their combination. Preferably functionalities 60 and 40 are integrated on a simple ASIC, having CPU on one digital SOC. Digital processing functionality 40 includes functionalities 41.

In FIG. 6 two antenna preferable high-gain arrangements in the scope of the apparatus 100 top view are shown. On the left side we have vertical polarization 4 dipoles environment for Rx and Tx antenna respectively. In this arrangement we would like to achieve in the elevation small angle and wider angle in azimuth. On the left side we see the similar arrangement with horizontal polarization. It may be observed that horizontal arrangements requires lower size of the module, but on other side unwanted clutters may be larger.

The Tx and Rx antenna systems are preferably realized as the planar printed dipoles with ellipsoid-like antenna shapes, with the two parts printed on opposite sides of the dielectric layer, which also provides mechanical support. Prints on the opposite side of the dielectric area are depicted using dashed lines. Preferred antenna elements are fed by symmetrical strip lines. On the bottom of the Apparatus 100 the metalized reflector is introduced allowing radiation perpendicular to the printed antenna area. Symmetrical strip line may be advantageously connected to differential mm-wave inputs and outputs of the entity 10 by using metalized micro-vias produced by advanced polymer technology.

As preferred embodiment realization solution proposed Apparatus 100 is realized using polymer technology, without PCB structures.

The proposed apparatus 100, and its sub-system entity 10, can have optional functionality for direction of arrival detection also using CW operation mode. In that case for example, before reaching L switch value, azimuth angle toward the obstacle may be detected. This information in conjunction by approaching the switch value L, for switching from FMCW mode to CW mode, can be used to use the changed sets of the coefficients: A B, C, deepening of the detected angle of arrival. In praxis that means, if the vehicle which is parking toward the obstacle being in the azimuth specific angle, which is not perpendicular to the sensor, come close to the obstacle, toward the switch value L, that means that the obstacle is thin, and portion of the detecting receiving power for small distances is smaller as the obstacle is approaching sensor in perpendicular mode. So the corrected set of values, as some art of the automatic system calibration is than used, being depended on the obstacle angle in azimuth.

If the Apparatus 100 has besides FMCW distance sensing functionality also direction of the arrival functionality, this may be advantageously used with simple CW detection approach proposed in this invention. Namely, if with FMCW mode at distances larger than L switch value, Apparatus 100 is detecting the distance and azimuth angle towards the obstacle, this information can be advantageously used for adjustment of the coefficients in the CW mode operation. In practical implementation, that means, if vehicle is moving towards the obstacle, and if immediately before L switch value is achieved, angle of arrival, meaning direction in azimuth towards obstacle, is detected being different as being perpendicular to the sensor, that means the obstacle is thin, and the level of the detected Rx power in the CW mode operation will be smaller, compared to the perpendicular case. In that case changed set of the coefficients: A, B, and C will be applied for distance calculation, for values being smaller than L switch value. Set of the coefficients: A, B, and C are advantageously provided in the look up table for the ranges of the angle toward the obstacle. Those ranges and set of coefficients A, B, and C, are empirically set for the specific vehicle.

1: MM-wave parking sensor Apparatus 100, where mm-wave declares operation between 30 and 300 GHz, is including:
1. Planar antenna for transmitting mm-wave radio signals 22, where the high-gain planar antenna has at least two radiation elements;
2. Planar antenna for receiving mm-wave radio signals 21, where the high-gain planar antenna has at least two radiation elements;
3. Integrated mm-wave radio front end 10, implemented in arbitrary semiconductor technology, having on-chip integrated mm-wave voltage control oscillator, mm-wave power amplifier, mm-wave low noise amplifier, mm-wave down conversion mixer, digital control interface, power supply; and PLL, being able to provide FMCW operations and CW TX operation, having additionally coupling and power detection entity 70, which has:
Power detection functionality, being able to measure CW power level being received an at least one of possibly more antenna Rx inputs
4. Analog to digital conversion entity 30;
5. Digital processing functionality 40 including controlling functionality 41 and calculation and memory capacity for performing digital signal processing by arbitrary type of the realization options with Control functionality allowing switching from FMCW radar mode to the pure CW mode operation 80.
6. Interface to vehicle infrastructure 60, including one or more standardized automotive wired interfaces;
7. Supporting circuitry 50, including mechanical interface to vehicle infrastructure and supporting electronic circuitry for power supply of 100.

2. Method of operation of MM-wave Parking Sensor Apparatus 100 described in claim 1 where the method of operation includes:
Calculation of the distance using state of the art FMCW radar detection principles until the distances being equal and greater to the distance threshold value 1, which is preset for each specific application scenario for the distance measurements.
Switching to the CW operation mode by approaching distance level calculation in the distance range below distance threshold value 1
Measure the DC value being related to the Power level SOC functionality on at least one RX chains of the Apparatus 100.
Using look up table, labeling detected power level, calculates the distance of the object to the sensor by the polynomial equation, for the distances below distance threshold value 1.
Where the coefficients for polynomial equation are empirically pre-set for the concrete application scenario, for specific vehicle embodiment, of the proposed distance sensor deployment.

3. MM-wave Parking sensor Apparatus 100, described in claim 1 including additionally:
1. HW Functionality for detecting direction of the reflected wave arrival, being realized by the plurality of the system solution

4. Method of operation described in claim 2 by using MM-wave Distance Detection Sensor Apparatus 100 described in claim 3, where the method of operation includes additionally numerical changes of the polynomial coefficients, being related to the detected angle of arrival information.

5. Method of operation described in previous claims, where at least one more distance threshold value numbered N is introduced,
where N may have number 2 or large,
where distance threshold value numbered N, is smaller than distance threshold value 1
where, when N is larger than 2, each introduced consequent distance threshold value is smaller than previously set.

6. Apparatus 100 Method of operation described in previous claims, where Tx 21 and Rx antenna 22 are released with the 2*N number of radiation elements, where N takes integer values larger than zero, providing in the elevation plain for parking application narrowed radiation beam as in the elevation.

7. Apparatus 100 Method of operation described in claim 6, here N in Tx 21 antenna takes value larger than 1.
